(19) United States
(12) Patent Application Publication
(10) Pub. No.: US 2004/0148837 A1
(43) Pub. Date: Aug. 5, 2004

(54) Card holder protective of information bearing surface

(76) Inventor: Cameron P. Lewis, Toronto (CA)

Correspondence Address: John C. McMahon, PO Box 30069, Kansas City, MO, 64112, US

(21) Appl. No.: 10/358,828

(22) Filed: Feb. 5, 2003

(51) Int. Cl. G09F 3/18

(52) U.S. Cl. 40/654.01

(57) ABSTRACT

A card holder for an information bearing card which has an information-bearing sensitive area and a non-sensitive area. The card holder has a cover attachable to the card so as to cover the sensitive area. The inner side of the cover, which faces the card when the cover is attached to the card, has at least one raised portion such that, when the cover is attached to the card with the inner side facing the sensitive area, the raised portion maintains the cover at a stand off from the sensitive area. The card holder also has an attaching member mounted on the cover for attaching the cover to the card.

### FIELD OF THE INVENTION

The present invention relates to card holders, and particularly to card holders for information bearing cards that protect information bearing surfaces on the cards.

### BACKGROUND OF THE INVENTION

An information bearing card is a card having certain information stored on it. Typical information bearing cards include credit cards, bank cards, identification cards, transit passes, admission tickets, and the like. The information may be displayed on the face of the card or stored in a machine readable medium on the card, or both. For example, a credit card has imprinted and handwritten text and symbols on its face and a stripe of magnetic coating on one side of the card which stores machine readable data. The surface of a card within which information is stored or displayed is herein referred to as the information bearing surface.

An information bearing surface may be damaged due to contact with other objects. When damaged, a machine readable medium may become inaccessible; a display may become illegible; and the information originally stored on the card may thus be lost. To protect the information, it is desirable that the information bearing surface be protected from unintended and unnecessary contact with other objects.

Often, the information bearing surface has a sensitive area, in the sense that the area stores sensitive information br the area is prone to damage. For instance, the magnetic stripe on a magnetic stripe card is typically a sensitive area, as the magnetic stripe is susceptible to damage and is often used to store sensitive information.

To avoid card damage, protective card holders are useful and have been used widely. A common approach is to enclose the entire card within a protective casing. However, this type of card holder is not only bulky but also inconvenient to use because the information stored on a card is inaccessible when the card is enclosed in the casing. For example, to swipe a magnetic stripe card through a card reader, the card has to be completely withdrawn from the card holder.

Some known card holders allow a card to be used without being removed from the card holder. This type of card holder may cover the information bearing surface with a flap. When the flap is open, the information bearing surface is exposed and is accessible. When the flap is closed, it covers the information bearing surface, thus protecting the surface against foreign objects. However, the information bearing surface, particularly the sensitive area, on a card protected by such card holders may still be damaged.

Therefore, there is a need for a card holder that is compact, convenient to use, and protects the information bearing surface, especially the sensitive area, against contact with other objects.

### SUMMARY OF THE INVENTION

The present invention proposes a card holder that protects the information bearing surface, especially the sensitive area, on an information bearing card against unintended and unnecessary contact with other objects, including the card holder itself. The card holder provides a cover for covering the information bearing surface without touching the sensitive area on the card. The cover may be removable without withdrawing the card from the card holder.

In accordance with the purpose of the invention, as embodied and broadly described herein, an aspect of the invention is a card holder for an information bearing card which has an information bearing side comprising a sensitive area and a non-sensitive area. The card holder has a cover attachable to the card so as to cover the sensitive area. The inner side of the cover, which faces the card when the cover is attached to the card, has at least one raised portion such that, when the cover is attached to the card with the inner side facing the sensitive area, the raised portion maintains the cover at a stand off from the sensitive area. The card holder also has an attaching member mounted on the cover for attaching the cover to the card.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures illustrating example embodiments of the present invention,

FIG. 1 is a perspective view of an exemplary card holder embodying aspects of the present invention.

FIGS. 2A-2D are perspective views of a card and the card holder of FIG. 1 illustrating the operation of the card holder of FIG. 1.

FIGS. 3A-3B are cross-sectional views of the card and card holder of FIGS. 2A-2D, further illustrating the operation of the card holder of FIG. 1.

FIGS. 4A-4D are cross-sectional views of other exemplary embodiments of the present invention.

FIGS. 5A-5C are perspective views of additional exemplary embodiments of the present invention.

### DETAILED DESCRIPTION

In the drawings and the following description, like parts are given like reference numerals. To clearly show certain portions of the embodiments, the drawings are not made to scale.

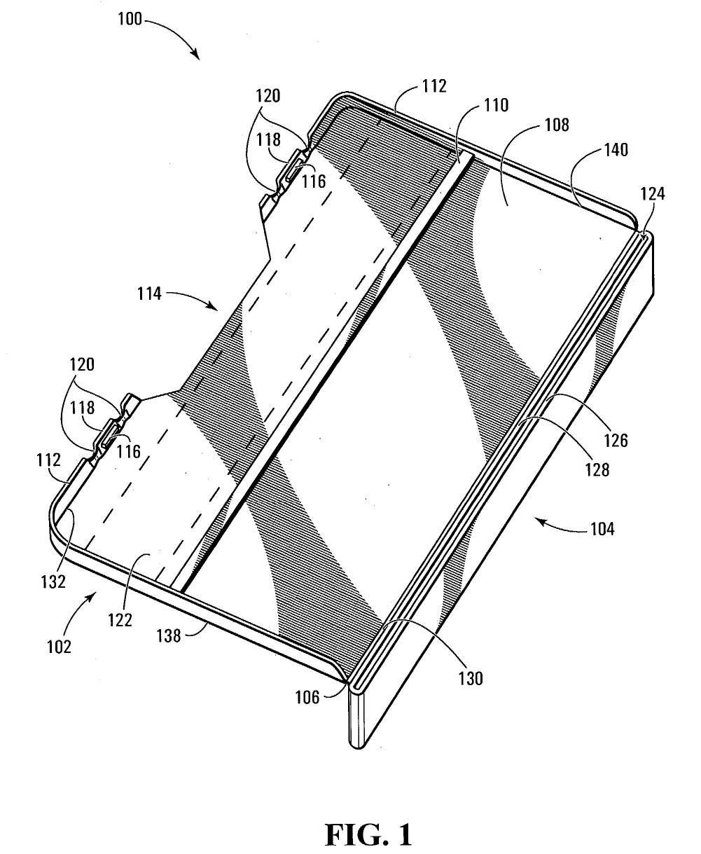

Referencing FIGS. 1 to 3B, an exemplary embodiment of the present invention is a card holder 100 for accommodating and protecting a typical, rectangular shaped, information bearing card 200, such as a credit card. The card 200 has an information bearing side 202 and a sensitive area 204 in the form of a strip near one edge 206 of the card, such as the magnetic stripe on a credit card. The area on the card 200 outside the sensitive area 204 is herein referred to as the non-sensitive area. As can be appreciated, the sensitive area 204 on a card 200 may require more protection than the non-sensitive area. For ease of reference, the distance between the edges 206 and 208 is referred to as the width of the card 200, and the distance between the two edges perpendicular to edge 206 as the length of the card 200. However, it is understood that the strip of sensitive area 204 may be parallel to either the longer sides or the shorter sides of the card 200.

The card holder 100 has a flap-like cover 102 hinged to a pocket 104 by a living hinge 106, all of which embodied on a single piece of semi-rigid plastic. Any suitable plastic or polymer material may be used. For example, polypropylenes or polyethylenes may be used.

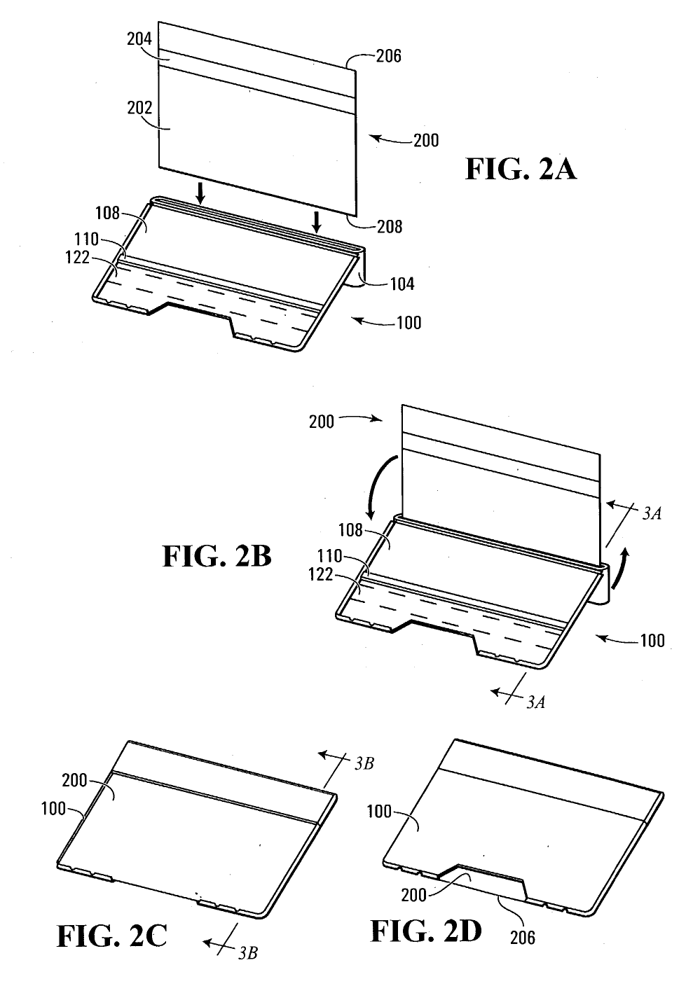

As illustrated in FIGS. 1, 2A and 2B, the pocket 104 is sized to partially accommodate the card 200. The pocket 104 comprises two elongate panels 126 and 128 joining at both ends and one of the sides, and thus defining a slot 124 with a width slightly wider than the thickness of the card 200 and a length slightly longer than the length of the card 200. The pocket 104 therefore can receive and cling to an edge 208 (or edge 206 as both edges are of the same length) of the card 200. The thickness of the panels 126 and 128 may vary, so long as the panels 126 and 128 are thick enough to be durable and to provide adequate protection to the card and yet thin enough so that the card holder 100 is not very bulky and is convenient to carry. For example, 0.7-0.8 mm thick plastic panels 126 and 128 may be adequate for holding a typical credit card.

It should be understood that hereinafter in this description the card 200 is always inserted into the pocket 104 with the information bearing side 202 facing the cover 102 and with the edge 208 of the card opposite the sensitive area 204 being inside the pocket. Also hereinafter, the phrase “the inserted card 200” refers to the card 200 that has been inserted into the pocket 104 in a manner as just described.

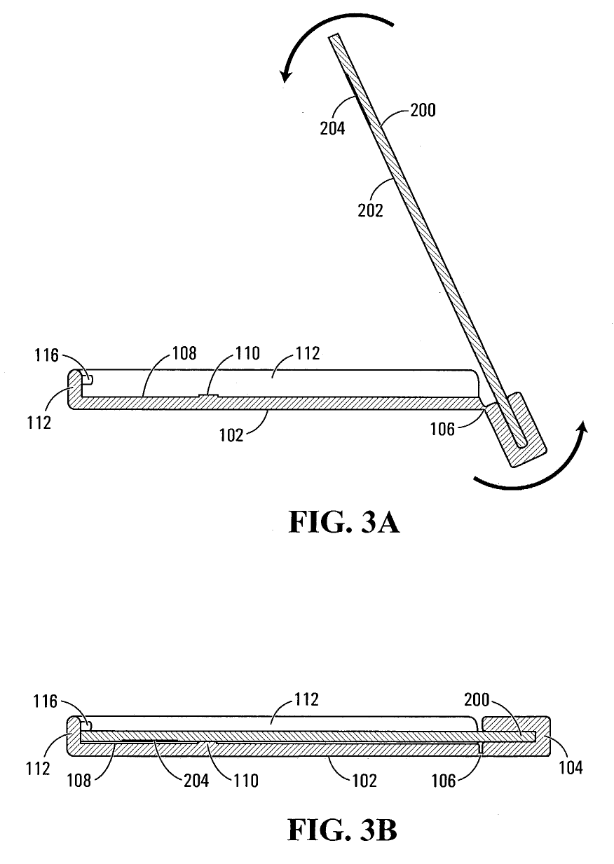

The depth of the slot 124 may vary but it should be sufficiently shallow such that when the card 200 is fully inserted into the slot 124, a sufficient portion of the card 200, including the sensitive area 204, is still outside the pocket 104, so that the information stored in the sensitive area can be accessed while the card 200 is fully inserted into the slot 124, as illustrated in FIGS. 2B and 3A. For example, the depth of the slot 124 may be roughly one tenth of the width of the card 200 between edge 206 and edge 208.

The living hinge 106 is a thin and narrow strip of plastic that connects an edge of one of the panels, panel 128 as illustrated in FIG. 1, along the opening of the slot 124 to an edge 130 of the cover 102. The strip is thin and resilient so that it can be folded easily and repeatedly without being ruptured. For a credit card holder made of plastic, a 0.2 mm thick and 0.66 mm wide living hinge strip has been found to be adequate. The width of the strip may vary but it should not be too wide or too narrow. Too wide a strip may reduce protective coverage and increase susceptibility to breakage, while too thin a strip may not operate well as a hinge.

The cover 102 is sized to match the size of the card 200 and to cover the side 202 of the card 200 that remains outside the pocket 104 when the card is fully inserted. The cover 102 may have a length the same as that of the pocket 104. When the depth of the pocket 104 is about one tenth of the width of the card 200, the width of the cover 102 may be roughly nine tenths of the width of the card 200. The cover 102 can freely rotate at the hinged edge 130 with respect to the pocket 104 within a certain range such that the cover 102 can be rotated to either expose or cover the side 202 of the inserted card 200. The cover 102 can be in one of two different states with respect to the inserted card 200: an open state and a closed state. FIGS. 2B and 3A illustrate the open state. FIGS. 2C (front view), 2D (back view), and 3B (side view), illustrate the closed state. As illustrated, in the closed state, the cover 102 and the pocket 104 in combination cover the entire information bearing side 202 of the card 200. As can be appreciated, this can be accomplished with a wider or narrower cover 102 and a concomitantly shorter or deeper pocket 104.

The inner side 108 of the cover 102, which is the side facing the inserted card 200, has a generally flat surface. In the closed state, the area 122 marked by the dashed lines in FIGS. 1, 2A and 2B on the inner side 108 would be directly opposite the sensitive area 204 on the card 200. The inner side 108 of the cover 102 has at least one projection projecting from the flat surface outside the area 122. In the particular embodiment illustrated in FIGS. 1-3B, the projection is a ridge 110 which extends across the surface of the inner side 108 along a boundary of the area 122 and just outside the area 122. The ridge may be on either side of the area 122 but preferably is on the side nearer the pocket 104 for reasons that will become clear below. The ridge 110 has a generally rectangular transverse cross section, viewed from the side [e.g., along view line 3A-3A in FIG. 2B]. The ridge 110 is sufficiently high to provide, in the closed state, a sufficient stand off or clearance between the area 122 of the cover 102 and the sensitive area 204 of the card 200, so as to prevent the cover 102 from contacting the sensitive area 204. As can be appreciated, the optimal height of the ridge may depend on a number of factors such as the size of the area 122, the strength and rigidity of the card holder material, the distance between the ridge 110 and the area 122. For a typical information bearing card such as a credit card and with a ridge 110 positioned within 3 mm from the area 122, a height of 0.25 mm has been shown to provide sufficient clearance between the cover 102 and the sensitive area 204 of the card 200.

In the embodiment illustrated in the figures, the cover 102 is generally as thick as the panel 128 of the pocket 104. However, the cover 102 may be thicker or thinner than the panel 128, so long as the cover 102 is thick enough to provide durable protection and yet sufficiently thin for convenience of storing and carrying.

A wall 112 extends upwards from the inner side 108 of the cover 102 along the unhinged edges. The inner dimension of the wall is such that the inserted card 200 will clear the wall 112 when the cover 102 is closed but the gap between the card 200 and the wall 112 is small. The height of the wall 112 is larger than the thickness of the card 200. The wall 112 may be generally as thick as the cover 102.

The wall 112 and the edge 132 of the cover opposite the hinge 106 is punctuated by a notch 114, the benefit of which will become clear below. On each side of the notch 114, a tab 116 extends inwardly towards the pocket 104 from a section 118 of the wall 112, overlaying a portion of the inner side 108, such that there is a space between the tab 116 and the surface of the inner side 108 of the cover 102, as illustrated in FIGS. 1, 3A and 3B. The tabs 116 may be of a generally rectangular shape. The clearance between the tab 116 and the inner side 108 of the cover 102 is large enough so that the edge 206 of the card 200 can be inserted between the tab 116 and the inner side 108 of the cover. The tabs 116 protrude from the wall 112 for a sufficient distance so that, in the closed state, each tab 116 engages the inserted card 200 to prevent the card from being separated from the cover 102 inadvertently. As the tabs 116 are resilient and do not protrude from the wall 112 very far, the inserted card 200 can be snapped in or out of the engagement with the tabs 116 to allow the cover 102 to be opened or closed. The exact morphology of the tabs 116, also including their lengths (along the edge 132) and heights (upwards from the inner side 108 towards the top of the wall 112) may vary as can be understood by a person skilled in the art. Adjacent each wall section 118 is a small section 120 of the wall 112, which is lower and thinner than the neighboring sections. This enhances the flexibility of the tabs 116.

The notch 114 has a trapezoidal outline as illustrated in FIG. 1, but the outline may be of a different shape. As illustrated in FIG. 2C, the notch 114 exposes a sufficient portion of the card 200 in a closed state so that a user can disengage the card 200 from the tabs 116 and open the cover 102. The notch 114 should be sufficiently wide (along the edge 132) and deep (perpendicular to the edge 132) to allow easy access by a human finger. The notch 114, however, should not be so deep as to encroach into the area 122 marked by the dashed lines. An unnecessarily large notch 114 reduces the protected area and may not be desirable.

In operation, the card 200 may be inserted into the pocket 104 as shown in FIGS. 2A and 2B. To close the cover 102, the cover 102 is rotated towards the card 200 about hinge 106 (as illustrated in FIGS. 2B and 3A) until the edge 206 of the card 200 snaps into the space between the tabs 116 and the inner side 108 of the cover 102 (as illustrated in FIGS. 2C and 3B). The cover 102 will remain closed as long as the card 200 is engaged with the tabs 116. Normally the card 200 is carried in the card holder 100 with the cover 102 closed when the card 200 is not being used. When the cover 102 is closed, the information bearing side 202 faces the cover 102 and is therefore protected. Particularly, as illustrated in FIG. 3B, the sensitive area 204 on the card 200 is spaced from the inner side 108 surface of the cover 102 due to the raised ridge 110 and is thus protected against contact with both foreign objects and the cover 102 itself.

To access information stored on the card 200, the user may need to open the cover 102, which is effected by pulling the exposed portion of edge 206 of the card 200 in notch 114 (as illustrated in FIG. 2D) with a finger while holding down the card holder 100 to cause the card 200 to snap out from between the tabs 116 and the inner side 108 of the card holder 100. Once the cover 102 is open, the information stored on the information bearing side 202 can be accessed without taking the card 200 out of the pocket 104. For example, if the card 200 is a credit card and the sensitive area 204 is a magnetic stripe on the card, the card can be swiped through a suitable card reader without taking the card 200 out of the pocket 104.

As will be understood by an ordinary skilled person in the art, many modifications to the exemplary embodiments described above are possible. As can be appreciated, as long as the inner side 108 has a sufficiently raised portion outside the area 122, the raised portion will maintain the cover 102 at a stand off from the sensitive area 204 in a closed state. Thus, the raised portion of the inner side 108 may be of any number of different forms.

For instance, the transverse cross section of the ridge 110 can be of any suitable morphology. Particularly, the shape of the cross section may be any suitable shape such as a square, rectangle, trapezium, trapezoid, half circle, half ellipse, or the like.

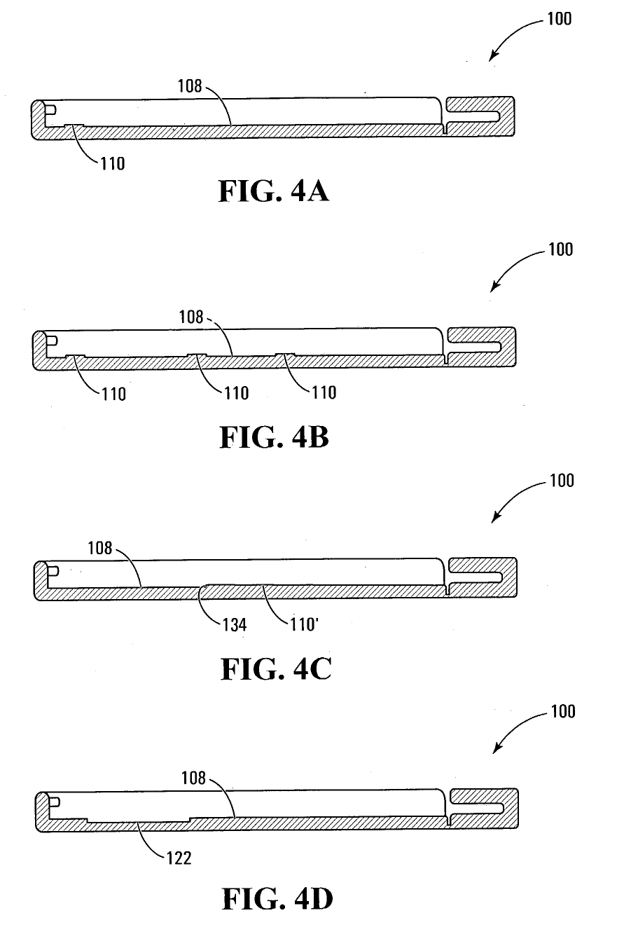

In addition, as alluded to earlier, the ridge 116 may be placed at a location different from the one shown in FIGS. 1 to 3B. For example, the ridge 110 may be positioned closer to the pocket 104 than as shown in FIG. 1, or on the other side of area 122 as illustrated in FIG. 4A. If the ridge 110 is distant from the area 122, however, the height of the ridge 110 may have to be significantly increased in order to protect the sensitive area 204, which may in turn cause an increase in the overall size of the card holder 100 and may not be desirable.

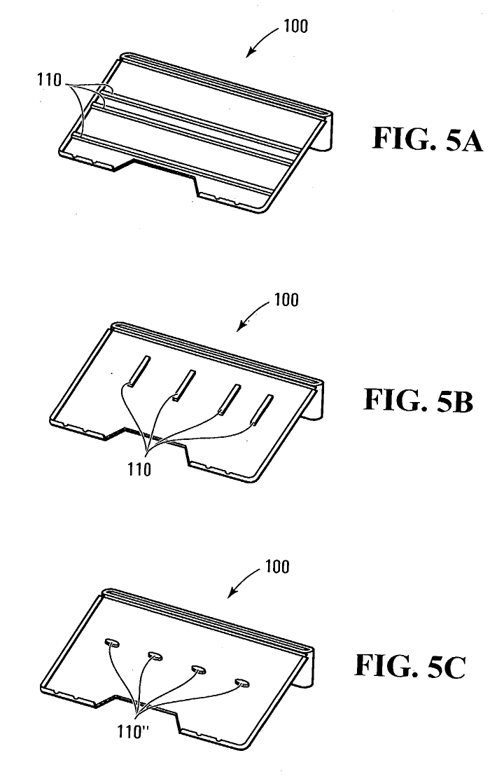

Further, instead of a continuous ridge, the raised portion may also comprise a plurality of discrete ridges 110, each of similar or different heights, as illustrated in FIGS. 4B, 5A and 5B. Instead of running parallel to the hinged edge 130 of the cover 102, one or more ridges may run perpendicular (as illustrated in FIG. 5B) or at any angle (not shown) to the hinged edge 130 of the cover.

Alternatively, in place of a ridge, the inner side 108 can comprise two flat surfaces, a leveled surface and a slightly beveled surface 110′, separated by a step 134 just outside the area 122, as illustrated in FIG. 4C. The inserted card 200 will lay against the beveled surface 110′ with the leveled surface facing, but stood back from, the sensitive area 204 of the card 200. A further alternative configuration of the inner side 108 has a flat surface with a recessed area 122, as illustrated in FIG. 4D. In this configuration, the raised portion of the side 108 is the portion of the surface on the inner side 108 other than the recessed area 122.

The raised portion may also comprise one or more projections in other shapes such as buttons 110″ as illustrated in FIG. 5C. The buttons 110″ can have various sizes and plateau shapes such as rectangles, circles, triangles, and the like.

While different shapes and arrangement of the raised portion may all work to provide the desired benefit of providing a clearance between the cover 102 and the card 200, some shapes and arrangements may be advantageous as they are easier and more economical to manufacture, provide better performance, or provide additional benefits. For example, a rectangular or square ridge 110 running across the entire inner side 108 of the cover 102 continuously may be advantageous because it reinforces the mechanical strength of the cover 102 and is easy to manufacture. Placing a continuous straight ridge close to area 122 may also be advantageous because the ridge need not be as high as some other alternative placements and arrangements may require.

Other parts of the card holder 102 may also be modified. For instance, the wall 112 need not extend beyond the sections 118. For example, it is not necessary for the wall 112 to extend over the side edges 138 and 140. However, a wall extending over the side edges reinforces the cover and prevents foreign objects from getting in between the cover and the card when the cover is closed.

The number of tabs 116 may vary so long as is practical and useful, as can be understood by a person skilled in the art. The tabs 116 may also be placed at different locations, such as on the side edges 138 or 140 but close to the notched edge 132. If a tab 116 is placed too close to the hinged edge 130, the tab will not function as well as if positioned more remotely from the hinge 106, as can be appreciated. The advantages of the tabs 116 as described above and illustrated in the figures are that they have a compact and simple structure and are easy to manufacture. Nonetheless, other types of engaging construction, such as a hook, may be used.

Similar to the tabs, the notch 114 may be placed in a different location such as along the side edges 138 and 140 of the cover 102, or even in the middle of the cover, in the form of a window. As can be appreciated, if the notch 114 is placed too close to the hinge 106, it would be difficult to snap open the cover 102. Thus, it is advantageous to position the notch 114 along the edge 132.

The cover 102 may be wholly or partially transparent so that one can read the displayed information without opening the cover. Alternatively, the cover 102 may have one or more windows, so long as the windows do not expose the sensitive area 204 to potential damage. In cases where confidentially or privacy is desired, the cover 102 may be entirely opaque so as to hide the information displayed on the card 200.

In some situations, it may be desirable that the cover 102 and the pocket 104 are detachable. In such cases, the cover 102 and the pocket 104 may comprise two separate pieces of material. Further, the hinge 106 need not be a living hinge. Generally, however, it is more convenient to have a one-piece card holder so that the cover 102 cannot be separated from the pocket 104 and a user is less likely to lose the cover 102.

An embodiment of the present invention may be made of any suitable material. For instance semi-rigid materials such as plastic, hard rubber or soft metal may be used. The material should be sufficiently resilient and soft so that the card holder would not damage the card upon contact and that a card can be snapped into place with relative ease. Yet, the material should be sufficiently hard and rigid to provide adequate protection for the card 200. Light material may be advantageous as a card holder made of a light material is convenient to carry.

An embodiment of the present invention can be used to hold various types of information bearing cards, such as credit cards, bank cards, identification cards, membership cards, electronic tickets, passes such as transit passes, and the like, so long as it is desirable to protect a defined portion of the card which is more sensitive than the rest of the card and the card is rigid enough to stay engaged with the cover 102. As will be understood, the shape and the dimensions of the card holder 100 may be adjusted according to the type of cards with which the card holder is to be used.

Other features, benefits and advantages of the present invention not expressly mentioned above can be understood from this description and the drawings by those skilled in the art.

Although only a number of exemplary embodiments of this invention have been described above, those skilled in the art will readily appreciate that many modifications are possible therein without materially departing from the novel teachings and advantages of this invention. Accordingly, all such modifications are intended to be included within the scope of this invention as defined in the following claims.

What is claimed is:

1. A card holder for an information bearing card, a side of said card having an information-bearing, sensitive area and a non-sensitive area, said card holder comprising:
a. a cover attachable to said card so as to cover said sensitive area, said cover having an inner side which faces said card when said cover is attached to said card, said inner side having at least one raised portion such that, when said cover is attached to said card with said inner side facing said sensitive area, said at least one raised portion maintains said cover at a stand off from said sensitive area; and
b. an attaching member mounted on said cover for attaching said cover to said card.

2. The card holder of claim 1, further comprising a pocket hinged to an edge of said cover for receiving an edge of said card, said pocket being sufficiently shallow such that, when said card is inserted into said pocket, said sensitive area is outside of said pocket and is coverable by said cover.

3. The card holder of claim 2, wherein said attaching member comprises at least one resilient tab at an edge of said cover remote from said pocket for snap fitting said card between said inner side of said cover and said at least one resilient tab.

4. The card holder of claim 3, wherein said at least one raised portion comprises at least one projection from said inner side of said cover.

5. The card holder of claim 4, wherein said inner side of said cover comprises a generally flat surface with at least one ridge, said at least one ridge being opposite said non-sensitive area when said cover is attached to said card.

6. The card holder of claim 5, wherein said at least one ridge comprises a continuous ridge extending across said flat surface such that, when said cover is attached to said card, said ridge abuts said card along a strip adjacent and substantially parallel to an edge of said sensitive area.

7. The card holder of claim 6, wherein said cover has a notch at an edge of said cover remote from said pocket, said notch exposing a portion of said card to allow access by a human finger to snap said card from between said inner side of said cover and said at least one resilient tab.

8. The card holder of claim 7, wherein said notch is at an edge of said cover opposite said pocket.

9. The card holder of claim 8, wherein said at least one resilient tab comprises two tabs, one of said two tabs on each side of said notch.

10. The card holder of claim 9, wherein a wall extends from said inner side of said cover at said edge of said cover opposite said pocket, said wall being punctuated by said notch and said two tabs extending from said wall.

11. The card holder of claim 10, wherein sections of said wall neighboring a section of said wall from which one of said two tabs extends are shorter and thinner than said section of said wall from which said one of said two tabs extends, so as to increase the flexibility of said one of said two tabs.

12. The card holder of claim 11, wherein the card holder is made of a semi-rigid material.

13. The card holder of claim 12, wherein the card holder is made of a material selected from a group consisting of plastic, metal and rubber.

14. The card holder of claim 3, wherein said inner side comprises a flat surface with a recessed area, said recessed area being opposite said sensitive area when said cover is attached to said card with said inner side facing said sensitive area.

15. The card holder of claim 14, wherein said cover has a notch at an edge of said cover remote from said pocket, said notch exposing a portion of said card to allow access by a human finger to snap said card from between said inner side of said cover and said at least one resilient tab.

16. The card holder of claim 15, wherein said notch is at an edge of said cover opposite said pocket.

17. The card holder of claim 16, wherein said at least one resilient tab comprises two tabs, one of said two tabs on each side of said notch.

18. The card holder of claim 17, wherein a wall extends from said inner side of said cover at said edge of said cover opposite said pocket, said wall being punctuated by said notch and said two tabs extending from said wall.

19. The card holder of claim 18, wherein sections of said wall neighboring a section of said wall from which one of said two tabs extends are shorter and thinner than said section of said wall from which said one of said two tabs extends, so as to increase the flexibility of said one of said two tabs.

20. The card holder of claim 19, wherein the card holder is made of a semi-rigid material selected from a group consisting of plastic, metal and rubber.
